(19) United States
(12) Patent Application Publication
(10) Pub. No.: US 2025/0226503 A1
(43) Pub. Date: Jul. 10, 2025

(54) BATTERY PACK

(71) Applicant: TOYOTA JIDOSHA KABUSHIKI KAISHA, Toyota-shi (JP)

(72) Inventors: Hiroshi OTAKE, Toyota-shi (JP); Kotaro HORIGUCHI, Nagoya-shi (JP); Hiroaki SHIMAZAKI, Seto-shi (JP)

(73) Assignee: TOYOTA JIDOSHA KABUSHIKI KAISHA, Toyota-shi (JP)

(21) Appl. No.: 18/940,851

(22) Filed: Nov. 8, 2024

(30) Foreign Application Priority Data
Jan. 10, 2024 (JP) 2024-001647

(51) Int. Cl. H01M 50/242; H01M 50/209; H01M 50/264

(52) U.S. Cl. CPC H01M 50/242; H01M 50/209; H01M 50/264

(57) ABSTRACT

A battery pack includes a battery fastening member, a front-rear direction structural member, a plurality of right-left direction structural members, and a load transmitting member disposed in a vicinity of at least one side portion of a case, and fixed over the front-rear direction structural member and the right-left direction structural member. When a battery module is disposed on an inner side between two right-left direction structural members among the right-left direction structural members that are adjacent in a front-rear direction, and is fixed to the case by a connecting portion and a fastening portion, at least a part of an end portion of the load transmitting member on the front-rear direction structural member side is disposed on the inner side in the front-rear direction as compared with the fastening portion.

### CROSS-REFERENCE TO RELATED APPLICATION

This application claims priority to Japanese Patent Application No. 2024-001647 filed on Jan. 10, 2024, incorporated herein by reference in its entirety.

### BACKGROUND

### 1. Technical Field

The present disclosure relates to a battery pack.

### 2. Description of Related Art

In recent years, battery packs have been used in battery electric vehicles and so forth. An impact cushioning material is used with battery packs, since it is conceivable that external impact will be applied thereto. Japanese Unexamined Patent Application Publication No. 2013-062092 (JP 2013-062092 A) discloses an external cushioning material that can be manufactured at low costs and can protect battery packs from impact.

### SUMMARY

When external impact is applied to a battery pack due to collision of a vehicle or the like, and in particular, when a load is applied to a side face side of the battery pack, the load may be applied to a battery module stored therein. Accordingly, there is demand for increased protection capabilities regarding the battery module that is stored, even when an impact is applied from outside of the vehicle, in order to further enhance safety.

The present disclosure has been made in view of the above-described problems, and provides a battery pack in which protection capabilities of a battery module that is stored are enhanced.

A battery pack according to the present disclosure includes:
a battery fastening member including a fastening portion for fixing a battery module that includes a connecting portion to a case using the connecting portion,
a front-rear direction structural member that is disposed in a vicinity of a side portion of the case and that extends in a front-rear direction,
a plurality of right-left direction structural members of which end portions abut the front-rear direction structural member, and that also extend in a right-left direction disposed orthogonal to the front-rear direction structural member, and
a load transmitting member disposed in a vicinity of at least one side portion of the case, and fixed over the front-rear direction structural member and the right-left direction structural member, in which,
when the battery module is disposed on an inner side between two right-left direction structural members among the right-left direction structural members that are adjacent in the front-rear direction, and is fixed to the case by the connecting portion and the fastening portion,
at least a part of an end portion of the load transmitting member on the front-rear direction structural member side is disposed on the inner side in the front-rear direction as compared with the fastening portion.

Accordingly, when a load is applied to the battery pack, the load can be guided through the load transmitting member such that a large load is not applied to the battery module.

According to the present disclosure, a battery pack can be provided in which protection capabilities of the battery module that is stored are enhanced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a top view of a battery pack according to the present disclosure;

FIG. 2 is an enlarged top view of primary portions of the battery pack according to the present disclosure;

FIG. 3 is an enlarged top view of primary portions of the battery pack according to the present disclosure;

FIG. 4 is an enlarged perspective view of primary portions of the battery pack according to the present disclosure;

FIG. 5 is an enlarged perspective view of primary portions of the battery pack according to the present disclosure;

FIG. 6A is an enlarged top view of primary portions of the battery pack according to the present disclosure; and

FIG. 6B is an enlarged top view of primary portions of the battery pack according to the present disclosure.

### DETAILED DESCRIPTION OF EMBODIMENTS

### First Embodiment

Hereinafter, specific embodiments to which the disclosure is applied will be described in detail with reference to the drawings. Note however, that the disclosure is not limited to the following embodiments. Also, for clarity of explanation, the following description and the drawings are simplified as appropriate.

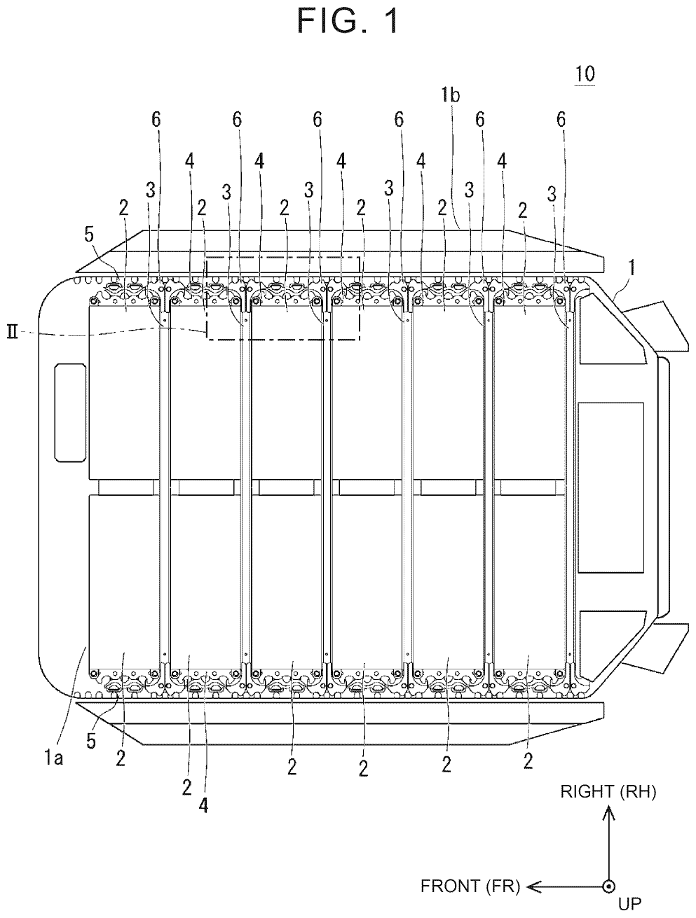

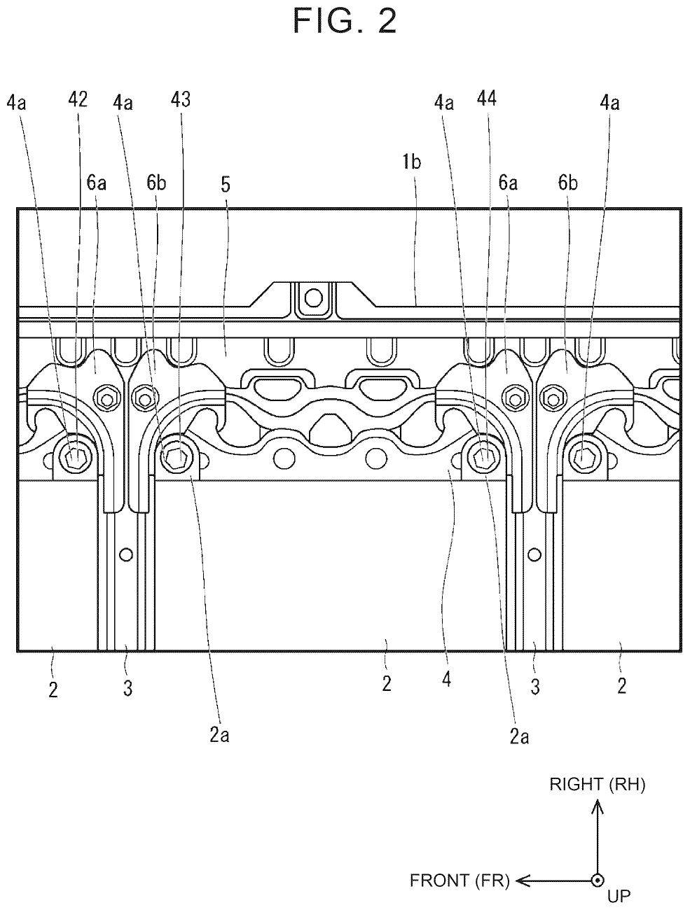

Hereinafter, a battery pack according to the present embodiment will be described with reference to the drawings. FIG. 1 is a top view of the battery pack according to the present disclosure. FIG. 2 is an enlarged top view of primary portions of the battery pack, encompassed by long dashed short dashed lines in FIG. 1.

Here, description will be made in which a left side direction in FIGS. 1 and 2 is a forward direction (Fr direction) of a battery pack 10 when installed in a vehicle, and an upper direction in FIGS. 1 and 2 is a right direction (RH direction) of the battery pack 10 when installed in the vehicle.

As illustrated in FIGS. 1 and 2, the battery pack 10 includes a case 1, battery modules 2, a plurality of right-left direction structural members 3, battery fastening members 4, front-rear direction structural members 5, and load transmitting members 6.

Hereinafter, a right-left direction of the battery pack 10 when installed in the vehicle may be referred to as a side direction. In both a front-rear direction and the right-left direction, a direction closer to the center of the battery pack 10 is defined as an inner side, and an opposite direction as an outer side. For example, a direction in which the battery modules 2 are provided in the case 1 is defined as the inner side in the front-rear direction. Conversely, a direction in which right-left direction structural members 3 are provided arrayed continuously in the front-rear direction so as to sandwich the battery modules 2 is defined as the outer side in the front-rear direction.

The case 1 is a case that houses the battery modules 2, the right-left direction structural members 3, the battery fastening members 4, and the front-rear direction structural members 5. The battery pack 10 includes a plurality of each of the battery modules 2, the right-left direction structural members 3, the battery fastening members 4, the front-rear direction structural members 5, and the load transmitting members 6. The case 1 has a bottom face la (see FIG. 1). Note that end portions of an outer shape of the case 1 in the right-left direction may be described as being side portions of the case 1. Note that the side portions of the case are side portions 1b.

More specifically, the right-left direction structural members 3, the battery fastening members 4, and the front-rear direction structural members 5 are respectively provided on the bottom face 1a. The battery modules 2 are, for example, lithium-ion batteries or the like.

Each battery module 2 has a rectangular shape extending in the front-rear direction and the right-left direction. The battery modules 2 are disposed on the inner side of the case 1 in the front-rear direction, each between two adjacent right-left direction structural members 3 out of the multiple right-left direction structural members 3.

Also, each of the battery modules 2 has connecting portions 2a protruding from side portions in the right-left direction. Further, the connecting portions 2a are fixed to the case 1 via fastening portions 4a of the battery fastening members 4, which will be described later, such that the battery modules 2 are fixed to the case 1. Here, a configuration is assumed in which the connecting portions 2a are each provided with a hole that passes through in an up-down direction, and by which the connecting portions 2a can be bolted.

Here, the battery modules 2 are each provided with two connecting portions 2a protruding to the right direction from the right side portion, on a forward side and a rearward side thereof, and the same is true regarding the side portion on the left side as well. That is to say, the connecting portions 2a of the battery modules 2 are formed so as to protrude from each of the corner portions of the battery modules 2 that are rectangularly shaped, toward the side portions 1b sides of the case 1 close thereto.

Note that bus bars that electrically mutually connect the battery cells making up the battery modules 2 are disposed on side portions of the battery modules 2 in the right-left direction.

Hereinafter, in order to simplify description of the configuration of the battery pack 10, description will be made focusing on the vicinity of the right side of the battery module 2, but the same configuration can be employed for the vicinity of the left side of the battery module 2.

As illustrated in FIG. 2, the right-left direction structural members 3 are battery pack inner structural members (inner cross-members) having a predetermined height upward from the bottom face la and also extending in the right-left direction. Further, the right-left direction structural members 3 are arrayed continuously in a state of being separated from each other by a predetermined distance at substantially equal intervals in the front-rear direction.

The front-rear direction structural member 5 is a battery pack inner structural member, and is disposed in the vicinity of the side portion 1b of the case 1. The front-rear direction structural member 5 is provided having a predetermined height upward from the bottom face la, and also extending in the front-rear direction. It should be noted that the front-rear direction structural member 5 may be further provided at positions other than the vicinity of the side portion 1b of the case 1, but will be described here as being provided only in the vicinity of the right and left side portions 1b of the case 1.

Here, the right-left direction structural members 3 are arrayed such that end portions thereof abut against the front-rear direction structural members 5, and also extend in an orthogonal direction with respect to the front-rear direction structural members 5, i.e., in the right-left direction.

The battery fastening members 4 are disposed between the side portions of the battery modules 2 in the right-left direction, and the front-rear direction structural members 5. The battery fastening members 4 are each provided with a plurality of the fastening portions 4a that are holes through which bolts can pass in the up-down direction. Regarding the positions of the battery fastening members 4 in the up-down direction, typically, portions of the battery fastening members 4 are disposed sandwiched between the load transmitting members 6 and the connecting portions 2a, the load transmitting members 6 are disposed below the battery fastening members 4, and the connecting portions 2a of the battery modules 2 are disposed upward from the battery fastening members 4.

For example, the battery modules 2 and the battery fastening members 4 are disposed such that the positions of the holes provided in the connecting portions 2a and the holes provided in the fastening portions 4a are aligned on a straight line in the up-down direction. The battery modules 2 and the battery fastening members 4 can be fixed to each other by bolting, using these holes.

The load transmitting members 6 are fixed over the right-left direction structural members 3 and the front-rear direction structural members 5. Accordingly, the load transmitting members 6 are provided in the vicinity of the side portion 1b of the case 1.

Specifically, the load transmitting members 6 are disposed so as to cover a part of each of the right-left direction structural members 3 and the front-rear direction structural members 5.

Also, the load transmitting members 6 have shapes extending in the front-rear direction at positions covering the front-rear direction structural members 5. Specifically, at least a part of end portions of the load transmitting members 6 on the side of the front-rear direction structural members 5 is formed to be long in the front-rear direction, by turning from an extension of the right-left direction structural members 3 in a top view, toward the side of the battery modules 2 in the front-rear direction.

The load transmitting members 6 are formed to be long in the front-rear direction at positions covering the front-rear direction structural members 5. In other words, at the end portions in the vicinity of the side portion in the right-left direction of the load transmitting members 6, at least part of the portions extending in the front-rear direction are disposed on an inner side in the front-rear direction as compared with the fastening portions 4a of the battery fastening members 4.

Therefore, in the load transmitting members 6, at least part of the end portions on the front-rear direction structural member 5 side are in a state of being disposed on the inner side of the connecting portions 2a in the front-rear direction via a space between the side portion 1b of the case 1 and the connecting portions 2a disposed closest to the load transmitting members 6.

The load transmitting members 6 may have shapes that extend only in the forward direction at an end portion on the front-rear direction structural member 5 side, or may have shapes that extend only in the rearward direction. In this case, with respect to the position where the right-left direction structural member 3 and the front-rear direction structural member 5 abut at one position, one of the load transmitting members 6 can each be respectively disposed, one of which the end portion on the front-rear direction structural member 5 side extends in the forward direction, and one extending in the rearward direction.

On the other hand, the load transmitting member 6 may be a single member of which the end portion on the front-rear direction structural member 5 side extends in both directions in the front-rear direction.

For example, an assumption will be made that at least two connecting portions 2a are disposed arrayed in the front-rear direction on one side portion in the right-left direction of one battery module 2, and the fastening portions 4a of corresponding battery fastening members 4 are disposed. Here, for the sake of description, among the fastening portions 4a for fixing the battery module 2 close to the forward side of the load transmitting member 6, a fastening portion 4a provided on the forward side will be referred to as a fastening portion 41 (omitted from illustration) and one provided on the rearward side as a fastening portion 42. Similarly, among the fastening portions 4a for fixing the battery module 2 close to the load transmitting members 6 on the rearward side, the fastening portion 4a provided on the forward side will be referred to as a fastening portion 43, and the fastening portion 4a provided on the rearward side as a fastening portion 44.

The load transmitting member 6 has a shape in which the end portion on the front-rear direction structural member 5 side extends forward. In this case, at least a part of the portion extending forward is disposed on the forward side of the fastening portion 42 provided at the rearmost side among the fastening portions 4a disposed corresponding to the connecting portions 2a of the battery module 2 disposed close to the forward side with respect to the load transmitting member 6. Similarly, the load transmitting member 6 has a shape in which the end portion on the front-rear direction structural member 5 side extends rearward. In this case, at least a part of the portion extending rearward is disposed on the rearward side of the fastening portion 43 provided at the frontmost side among the fastening portions 4a disposed corresponding to the connecting portions 2a of the battery module 2 disposed close to the rearward side with respect to the load transmitting member 6.

Further, for the sake of description, with respect to the load transmitting member 6, the load transmitting member 6 having a shape extending forward will be referred to as load transmitting member 61, and the load transmitting member 6 having a shape extending rearward will be referred to as load transmitting member 62.

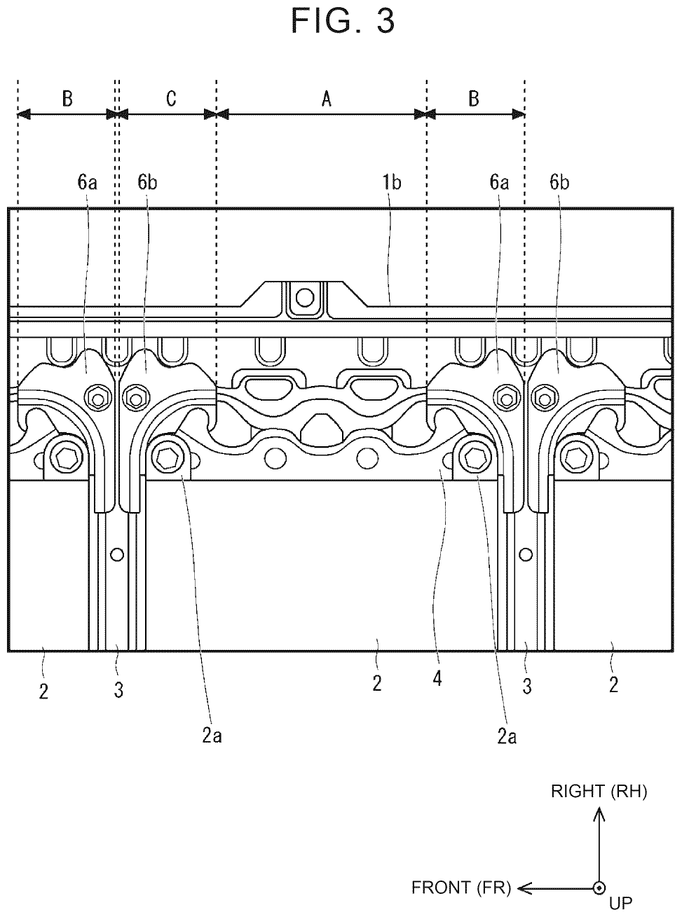

FIG. 3 is a top view illustrating primary portions of the battery pack, indicating the relationship between the load transmitting members 6 and the length related to the disposing thereof. As illustrated in FIG. 3, the load transmitting members 6 correspond to the right-left direction structural members 3 that are provided. The load transmitting members 6 are respectively provided with the load transmitting member (first load transmitting member) 61 extending forward and the load transmitting member (second load transmitting member) 62 having a shape extending rearward. In right-left direction structural members 3 that are adjacent, a distance from a rear end portion of the second load transmitting member 62 disposed corresponding to the right-left direction structural member 3 at the front, to a front end portion of the first load transmitting member 61 disposed corresponding to the right-left direction structural member 3 at the rear, is shorter than a length obtained by adding a distance from a front end portion to a rear end portion of the load transmitting member 61 and a distance from a front end portion to the rear end portion of the load transmitting member 62.

More specifically, as illustrated in FIG. 3, in the battery pack 10, a distance A between the portions where the load transmitting members 6 are separated from each other is shorter than a totaled length of a length B of one first load transmitting member 61 and a length C of one second load transmitting member 62. Thus, the shapes of the first load transmitting member 61 and the second load transmitting member 62 can be determined.

Note that the length of the load transmitting member 6 extending in the right-left direction, i.e., the length of the portion where the load transmitting member 6 covers the right-left direction structural member 3 can be optionally changed. Typically, an end portion on the inner side in the right-left direction of the load transmitting member 6 covering the right-left direction structural member 3 may be on the inner side of the connecting portion 2a of the battery module 2 in the right-left direction.

Also, the load transmitting member 6 can be fixed by bolts passing through holes provided in the load transmitting member 6 when the fastening portions 4a of the battery fastening member 4 and the connecting portions 2a of the battery module 2 are fixed using the bolts. Note that the method of fixing the load transmitting member 6 is not limited to the method of forming a hole and allowing a bolt to pass through the hole. For example, an arrangement may be made in which the load transmitting member 6 is not provided with a hole, and can be fixed by pressing the battery fastening member 4 downward from above at a position that differs from the fastening portions 4a and the connecting portions 2a when the fastening portions 4a and the connecting portions 2a are fixed by bolts.

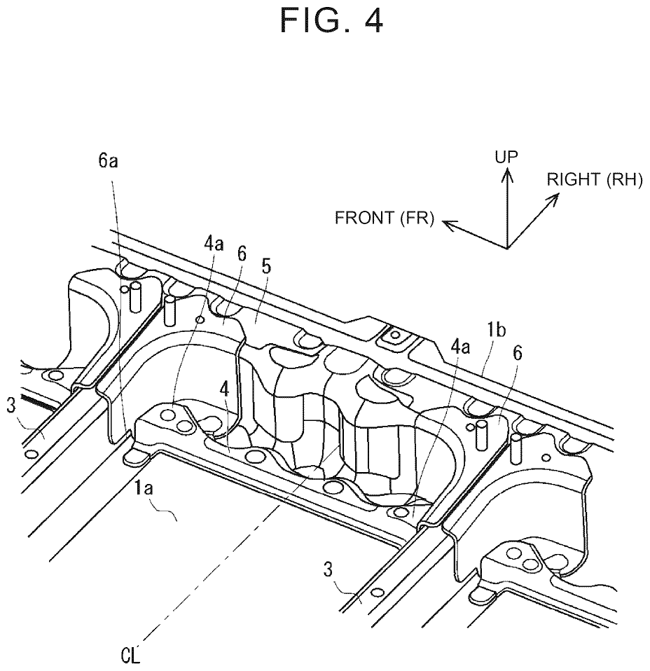

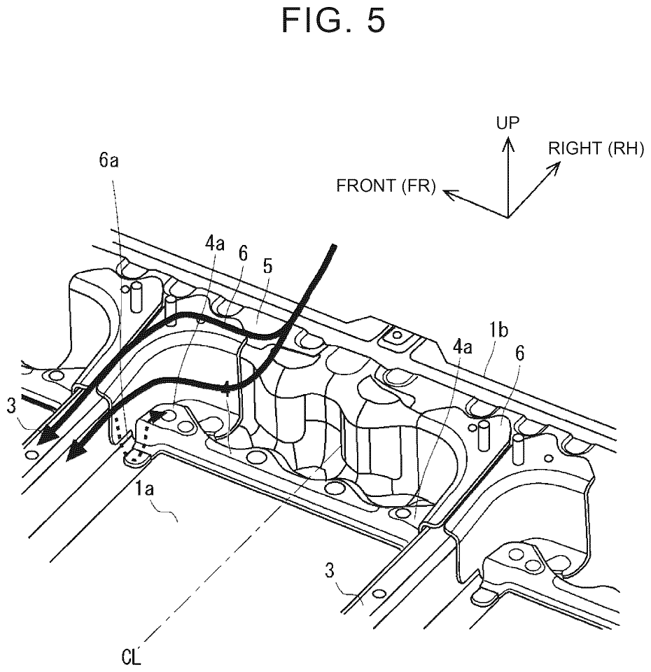

FIG. 4 is an enlarged perspective view of primary portions of the battery pack illustrated in FIG. 1. FIG. 5 is an enlarged perspective view of a primary portion of the battery pack as in FIG. 4, and an example of a load path for distributing a load is indicated by an arrow. Note that in FIGS. 4 and 5, the battery modules 2 are omitted from illustration. Now, in the load transmitting member 6, a cutout portion 6a is formed in the vicinity of a corner portion of the battery module 2, which is in a portion close to the battery fastening member 4.

Due to the cutout portion 6a being provided in the load transmitting member 6, a state in which three layers of the right-left direction structural member 3, the battery fastening member 4, and the load transmitting member 6 are not joined to each other can be realized. That is to say, the load transmitting member 6 is provided with the cutout portion 6a at least in a portion thereof, so as to form a portion to circumvent contact with the load transmitting member 6 and the battery fastening member 4. Thus, the right-left direction structural member 3 and the battery fastening member 4 can be brought into a state of direct contact with each other at a position away from the connecting portions 2a and the fastening portions 4a.

According to such a configuration, when a load is applied from the side portion of the battery pack 10, the load path is in a state of being diverted in the battery pack 10, as illustrated in FIG. 5. That is to say, when the load is transmitted from the load transmitting member 6 to the battery module 2, the load is in a state of following a route indicated by a dotted arrow in FIG. 5. In this route, force is less likely to be transmitted from the load transmitting member 6 to the battery module 2, and accordingly input of the load to the battery module 2 can be suppressed.

Also, an exemplary relation between a position where external force is applied when the external force is applied to the side portion 1b of the case 1, and the way in which a load is transmitted into the battery pack 10, will be described with reference to the drawings. 6A and 6B are enlarged top views of primary portions of the battery pack 10, and are diagrams in which examples of transmission of a load when a force is applied from the outside due to a collision or the like of the vehicle are each illustrated by arrows.

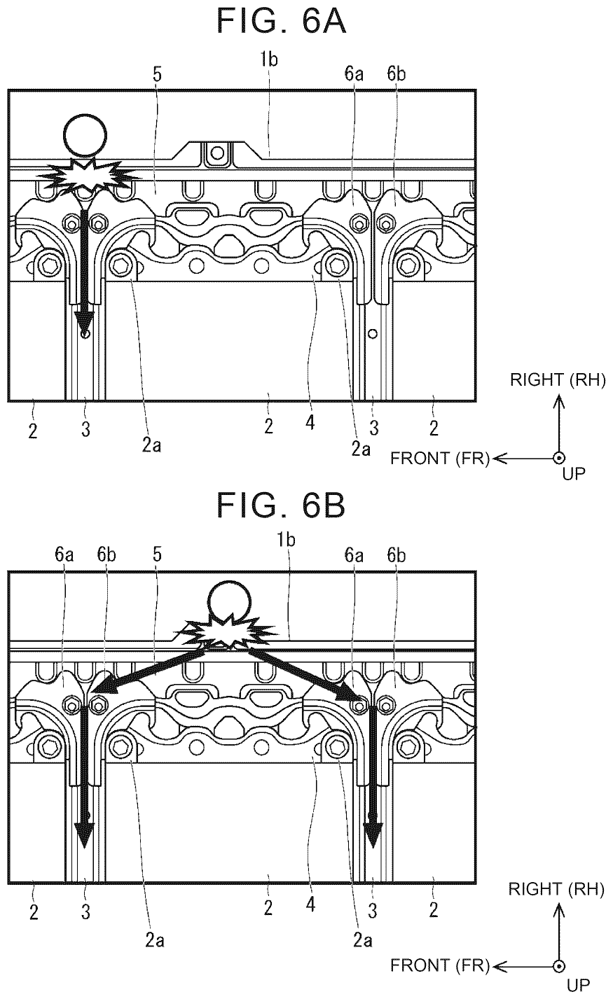

FIG. 6A is an example of a case in which a pole collides at a position at an extension from the right-left direction structural member 3, and a load is generated toward the inner side in the right-left direction from the right side of one right-left direction structural member 3. In this case, the battery pack 10 is in a state in which the load is applied to the right-left direction structural member 3 to the inner side in the right-left direction from the position where the pole collided. Accordingly, the battery pack 10 is in a state in which the load is less likely to be applied to the battery modules 2 and the battery fastening members 4.

On the other hand, FIG. 6B is an example in which a load is generated toward the inner side in the right-left direction at an intermediate position between the right-left direction structural members 3 adjacent in the front-rear direction, i.e., at a position on the right side of the battery module 2. In this case, in the battery pack 10, the load flows from the position where the pole collided to the load transmitting member 6 side, such that the load is distributed to each of the two right-left direction structural members 3 disposed on either side in the front-rear direction of the position where the pole collided. Accordingly, in the battery pack 10, a great load can be kept from being applied to the battery modules 2 and the battery fastening members 4.

Here, the first load transmitting member 61 has a shape in which the end portion on a side portion side in the right-left direction is extended in the forward direction. The second load transmitting member 62 has a shape extending in the rearward direction. Each of the end portions is set on the inner side of the fastening portions 4a of the battery fastening member 4 in the front-rear direction. In this case, with respect to the bending start points of the front-rear direction structural member 5, due to providing the load transmitting members 61 and 62 partially on the inner side of the fastening portions 4a in the front-rear direction, the distance between portions serving as the bending start points of the front-rear direction structural member 5 are more readily brought closer, as compared to when these are not provided.

Accordingly, the load transmitting members 61 and 62 are provided in the battery pack 10. Accordingly, even when the front-rear direction structural member 5 is bent due to an external collision, the battery fastening member 4 is less likely to be pushed to the inner side in the right-left direction by the front-rear direction structural member 5.

Further, in this case, the battery fastening member 4 pressed by the front-rear direction structural member 5 can be suppressed from pressing the bus bar disposed on the side portion of the battery module 2 toward the inner side in the right-left direction.

Also, as illustrated in FIG. 3, the lengths of the first load transmitting member 61 and the second load transmitting member 62 in the front-rear direction are sufficiently long. Accordingly, when a load is applied, a distance between a collision point when an obstruction strikes the outside of the battery pack 10, and a point acting as the bending start point in the front-rear direction structural member 5, can be made to be closer.

That is to say, in the front-rear direction structural member 5, the distance between the effort and the load of moment is shortened, and accordingly the bending rigidity can be improved.

Further, as illustrated in FIGS. 4 and 5, the load transmitting member 6 is provided with the cutout portion 6a. Thus, the right-left direction structural member 3, the battery fastening member 4, and the load transmitting member 6 can be placed in a state in which three sheets are not joined, i.e., in a state in which the load path is diverted. Accordingly, even when a load is applied from the outside of the vehicle, the input to the fastening portions 4a can be suppressed.

As described above, in the battery pack 10, the load transmitting members 6 each having a shape extending in the front-rear direction in the vicinity of the side portion of the battery pack 10 are disposed corresponding to each of the right-left direction structural members 3. Thus, the protection performance of the battery module 2 against external loads can be improved.

Note that the disclosure is not limited to the above-described embodiment, and can be modified as appropriate without departing from the spirit. That is to say, omissions and simplifications have been made as appropriate in the above description, for clarity of description, and one skilled in the art will be able to readily modify, add, or convert the elements of the embodiment within the scope of the disclosure.

What is claimed is:

1. A battery pack, comprising:
a battery fastening member including a fastening portion for fixing a battery module that includes a connecting portion to a case using the connecting portion;
a front-rear direction structural member that is disposed in a vicinity of a side portion of the case and that extends in a front-rear direction;
a plurality of right-left direction structural members of which end portions abut the front-rear direction structural member, and that also extend in a right-left direction disposed orthogonal to the front-rear direction structural member; and
a load transmitting member disposed in a vicinity of at least one side portion of the case, and fixed over the front-rear direction structural member and the right-left direction structural member, wherein, when the battery module is disposed on an inner side between two right-left direction structural members among the right-left direction structural members that are adjacent in the front-rear direction, and is fixed to the case by the connecting portion and the fastening portion, at least a part of an end portion of the load transmitting member on the front-rear direction structural member side is disposed on the inner side in the front-rear direction as compared with the fastening portion.

2. The battery pack according to claim 1, wherein:
the battery module is rectangular in shape and extends in the front-rear direction and the right-left direction;
in the case, the connecting portion of the battery module is fashioned so as to protrude from each corner of the battery module that is rectangular, toward a side portion side of the case in the vicinity; and
at least a part of the end portion of the load transmitting member, on the front-rear direction structural member side, is disposed on the inner side in the front-rear direction than the connecting portion, via a space between the side portion of the case and the connecting portion disposed closest to the load transmitting member.

3. The battery pack according to claim 1, wherein:
the end portion of the load transmitting member on the front-rear direction structural member side is fashioned so as to extend in at least one direction of the front-rear direction;
when the end portion of the load transmitting member on the front-rear direction structural member side is shaped extending forward, at least a part of the portion extending forward is disposed on a forward side of the fastening portions provided rearmost of the fastening portion disposed corresponding to the connecting portion of the battery module disposed close to a forward side of the load transmitting member; and
when the end portion of the load transmitting member on the front-rear direction structural member side is shaped extending rearward, at least a part of the portion extending rearward is disposed on a rearward side of the fastening portions provided frontmost of the fastening portion disposed corresponding to the connecting portion of the battery module disposed close to a rearward side of the load transmitting member.

4. The battery pack according to claim 1, wherein:
the load transmitting member is
a first load transmitting member including a forward-direction extending portion, and
a second load transmitting member including a rearward-direction extending portion;
the first load transmitting member and the second load transmitting member are provided corresponding to the right-left direction structural members, respectively; and
in adjacent ones of the right-left direction structural members, a distance from a rear end portion of the second load transmitting member disposed corresponding to the right-left direction structural member to the front, to a front end portion of the first load transmitting member disposed corresponding to the right-left direction structural member to the rear, is shorter than a length obtained by adding a distance from the front end portion to a rear end portion in the first load transmitting member and a distance from a front end portion to the rear end portion in the second load transmitting member.

5. The battery pack according to claim 1, wherein the load transmitting member includes a cutout portion for suppressing contact with the battery fastening member.
